(19) United States
(12) Patent Application Publication
(10) Pub. No.: US 2016/0095788 A1
(43) Pub. Date: Apr. 7, 2016

(54) Massage Device

(71) Applicant: Theresa Cottrell, Birmingham, AL (US)

(72) Inventor: Theresa Cottrell, Birmingham, AL (US)

(21) Appl. No.: 14/504,658

(22) Filed: Oct. 2, 2014

(51) Int. Cl. A61H 23/00

(52) U.S. Cl. CPC A61H 23/00

(57) ABSTRACT

A massage device massages various parts of the body. The device includes a plurality of attachment members each configured for attachment to a particular body part. Each of a plurality of massage units is coupled to an associated one of the attachment members. Each massage unit comprises a substantially planar face, a plurality of sockets coupled to and extending into the planar face, and a plurality of contact members. Each contact member is positioned in and extends from an associated one of the sockets wherein an outer portion of each contact member extends from the planar face. Each massage unit has a plate abutting a base of each socket. The plate is selectively vibrated wherein each contact member vibrates. Each of a plurality of control units is coupled to an associated one of the attachment members. Each massage unit is operationally coupled to an associated one of the control units.

### BACKGROUND OF THE DISCLOSURE

### Field of the Disclosure

The disclosure relates to massage devices and more particularly pertains to a new massage device for massaging various parts of the body.

### SUMMARY OF THE DISCLOSURE

An embodiment of the disclosure meets the needs presented above by generally comprising a plurality of attachment members wherein each attachment member is configured for attachment to a part of a body. Each of a plurality of massage units is coupled to an associated one of the attachment members. Each massage unit comprises a substantially planar face, a plurality of sockets coupled to and extending into the planar face, and a plurality of contact members. Each contact member is positioned in and extends from an associated one of the sockets wherein an outer portion of each contact member extends from the planar face. Each massage unit has a plate abutting a base of each socket. The plate is selectively vibrated wherein each contact member vibrates. Each of a plurality of control units is coupled to an associated one of the attachment members. Each massage unit is operationally coupled to an associated one of the control units.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF THE DRAWINGS

The disclosure will be better understood and objects other than those set forth above will become apparent when consideration is given to the following detailed description thereof. Such description makes reference to the annexed drawings wherein:

FIG. 1 is a front view of a massage device according to an embodiment of the disclosure.

FIG. 2 is a front view of a torso massager of an embodiment of the disclosure.

FIG. 3 is a back view of a torso massager an embodiment of the disclosure.

FIG. 4 is a top front side view of an extremity massager of an embodiment of the disclosure.

FIG. 5 is a bottom side perspective view of a foot massager of an embodiment of the disclosure.

FIG. 6 is a top detail view of a control unit of an embodiment of the disclosure.

FIG. 7 is a cross-sectional view of an embodiment of the disclosure taken along line 7-7 of FIG. 1.

### DESCRIPTION OF THE PREFERRED EMBODIMENT

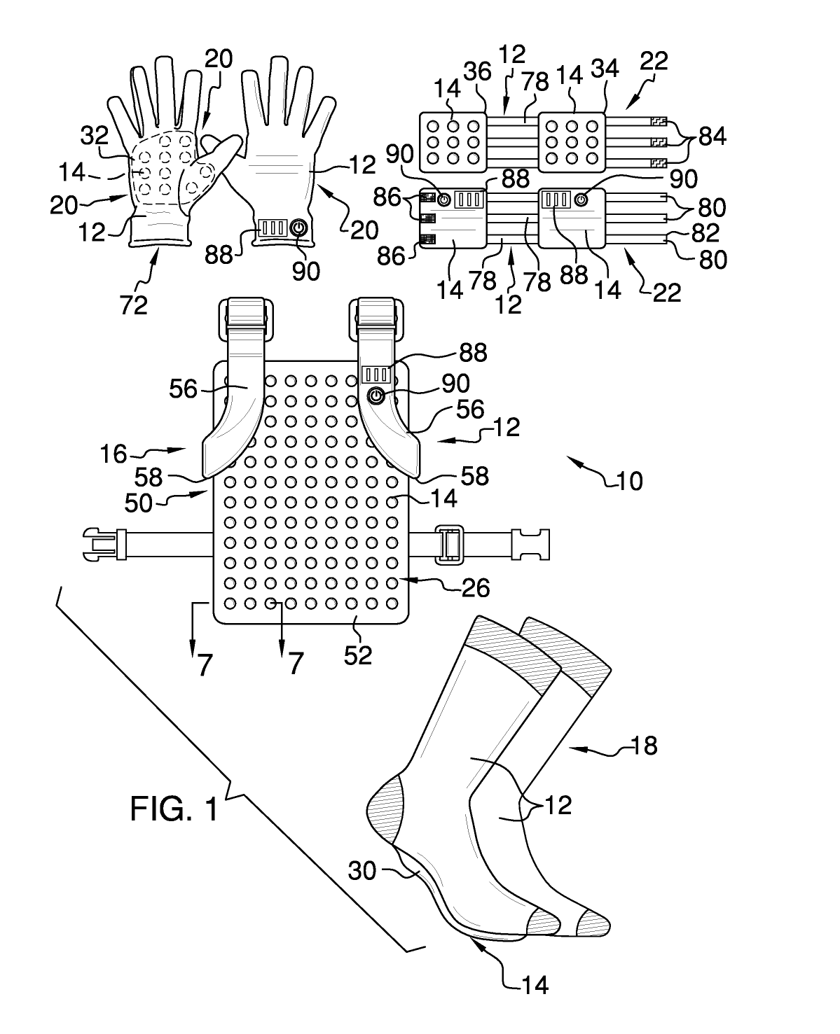

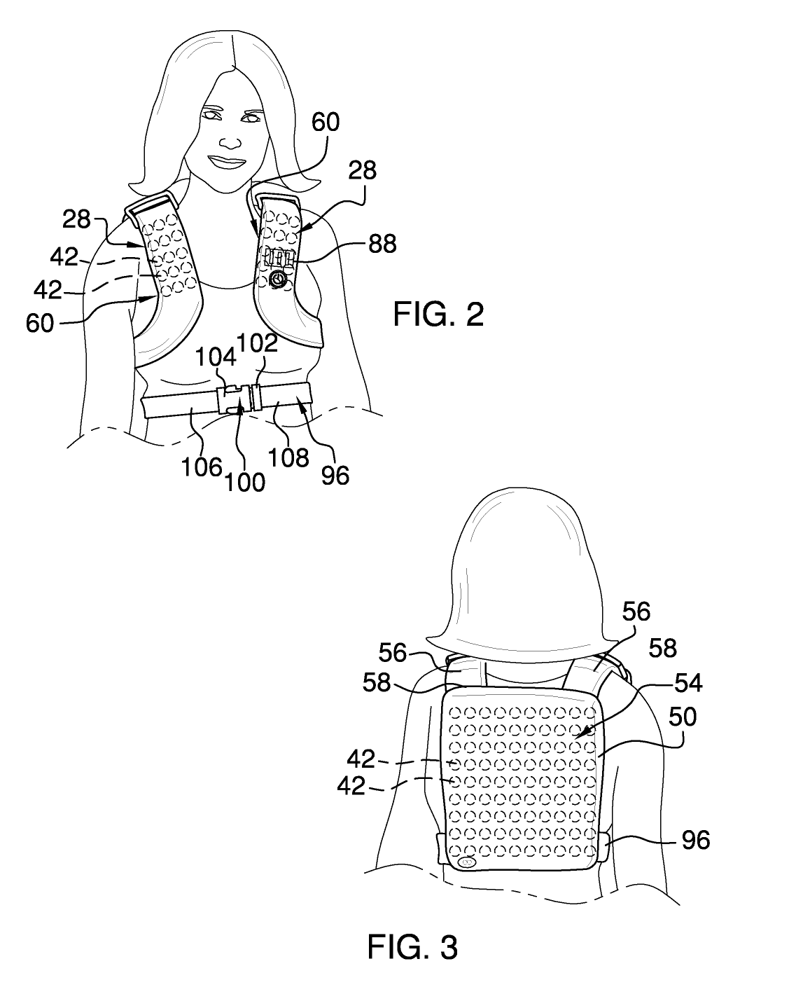

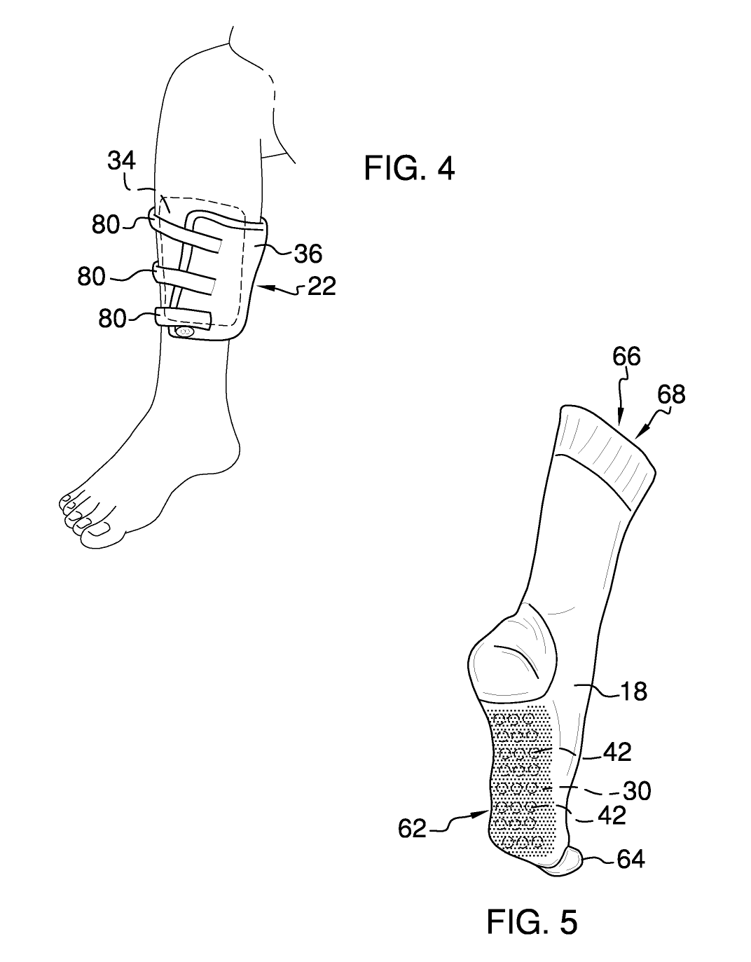

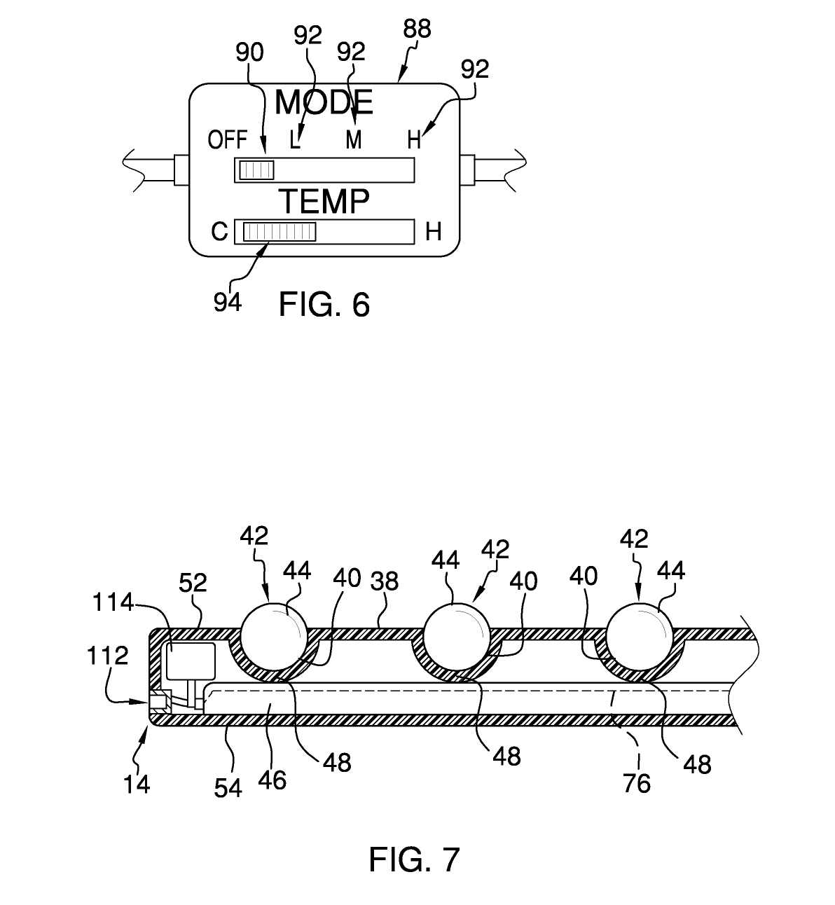

With reference now to the drawings, and in particular to FIGS. 1 through 7 thereof, a new massage device embodying the principles and concepts of an embodiment of the disclosure and generally designated by the reference numeral 10 will be described.

As best illustrated in FIGS. 1 through 7, the massage device 10 generally comprises a plurality of attachment members 12 and a plurality of massage units 14. Each attachment member 12 is configured for attachment to a specific part of a body. The attachment members 12 include a torso member 16, a sock member 18, a glove member 20, and an extremity member 22. The massage units 14 include a dorsal torso unit 26, a pair of shoulder units 28, a foot unit 30, a palm unit 32, and a pair of extremity units 34,36. Each massage unit 14 is coupled to an associated one of the attachment members 12.

The specific size and outer shape of each massage unit 14 may be configured uniquely for the specific body part the unit 14 will massage. However, each massage unit 14 includes similar structure, as exemplified in FIG. 7, including a substantially planar face 38 and a plurality of sockets 40 coupled to and extending into the planar face 38. A plurality of contact members 42 is provided. Each contact member 42 is positioned in and extends from an associated one of the sockets 40. An outer portion 44 of each contact member 42 extends from the planar face 38. The contact members 42 may be spherical whereby the outer portion 44 may be a segment of a sphere providing an arcuate or elliptical shape. Each massage unit 14 further has a plate 46. The plate 46 abuts a base 48 of each socket 40. The plate 46 is selectively vibrated wherein each contact member 42 also vibrates to provide the massaging action to the user. Each massage unit 14 may have an associated charging port 112 electrically coupled to a rechargeable power source 114 for the operational parts of the massage unit 14.

The torso member 16 may comprise a dorsal panel 50 having an interior face 52 and an exterior face 54. The torso member 16 also includes a pair of shoulder straps 56. Each of the shoulder straps 56 has opposite ends 58 coupled to the dorsal panel 50. Thus, the interior face 52 of the dorsal panel 50 is configured for abutting a back of a wearer when the shoulder straps 56 are extended over shoulders of the wearer. The dorsal torso unit 26 is coupled to the dorsal panel 50 such that the contact members 42 of the dorsal torso unit 26 extend from the interior face 52 of the dorsal panel 50. Each shoulder unit 28 is coupled to an associated one of the shoulder straps 56 such that the contact members 42 of each of the shoulder units 28 extends from an inwardly facing surface 60 of the associated shoulder strap 56. A chest strap 96 may be utilized having first and second ends 98 coupled to the dorsal panel 50. The chest strap 96 may have an adjustable length and a chest buckle 100 having selectively separable portions 102,104 coupled to respective first and second sections 106,108 of the chest strap 96.

The sock member 18 has a base section 62 extending along one side of a tube from a closed end 64 towards an open end 66. The base section 62 is designed to abut the sole of a foot inserted into the sock member 18 through the open end 66. The foot unit 30 is coupled to the sock member 18 such that the contact members 42 of the foot unit 30 extend inwardly into an interior space 68 of the sock member 18. The contact members 42 of the foot unit 30 extend from the base section 62 of the sock member 18 to massage the sole of the foot.

The glove member 20 has a palm section 70. The palm unit 32 is coupled to the glove member 20 such that the contact members 42 of the palm unit 32 extend inwardly into an interior space 72 of the glove member 20. The contact members 42 of the palm unit 32 extend from the palm section 70 of the glove member 20. A pair of glove members 20 may be similarly structured other than each being designed to correspond to a right or left hand of the wearer.

The massage units 14 include a first extremity unit 34 and a second extremity unit 36 used in tandem. The extremity member 22 may comprise at least one connection strap 78 coupled to and extending between the first extremity unit 34 and the second extremity unit 36. The connection strap 78 is flexible and may also be elastic. The extremity member 22 further includes a fastening strap 80 having a free end 82 removably coupled to the extremity member 22 either directly or by coupling through direct connection of the free end 82 to one of the extremity units 34,36. Thus, the extremity member 22 is configured for attachment around an extremity of the wearer such that the contact members 42 of the first and the second extremity units 34,36 face and contact the extremity of the wearer. The connection strap 78 may be one of a plurality of connection straps 78 coupled to and extending between the first extremity unit 34 and the second extremity unit 36. The fastening strap 80 may also be one of a plurality of fastening straps 80 coupled to the extremity member 22. Complimentary portions of hook and loop fastener 84,86 are coupled to the extremity member 22 and the fastening strap 80 wherein the fastening strap 80 is selectively and removably coupled to the extremity member 22.

A plurality of temperature elements 76 may also be provided. Each temperature element 76 is incorporated into the structure of the massage units 14 by being coupled to an associated one of the plates 46. Thus, each massage unit 14 may selectively provide heat transferred through the contact members 42 of the associated massage unit 14. Each massage unit 14 may also provide either heat or cold selectively in a conventional manner.

A plurality of control units 88 is also provided. Each control unit 88 is coupled to an associated one of the attachment members 12. Each massage unit 14 is operationally coupled to an associated one of the control units 88. Each control unit 88 may have an activation switch 90 operationally coupled to the plate 46 of each associated massage unit 14 attached to the associated attachment member 12. The activation switch 90 may have a plurality of settings 92 and be operationally coupled to the plate 46 of each associated massage unit 14 wherein the plate 46 of each associated massage unit 14 vibrates at a selectable intensity determined by the positioning of the activation switch 90. Each control unit 88 may further have a temperature switch 94 operationally coupled to the temperature element 86 of each associated massage unit 14. The temperature switch 94 may be a slider switch or similar structure employing a rheostat or the like to vary the temperature provided by activation of the temperature element 86.

In use, the appropriate attachment member 12 is selected based on the part of the body to be massaged. The attachment member 12 is coupled to the body and the activation switch 90 is manipulated to provide massage via the contact members 42 being vibrated by the plate 46 of the massage unit 14. Heat or cold may also be provided by utilization of the temperature switch 94.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure.

I claim:

1. A massage device comprising:
a plurality of attachment members, each attachment member being configured for attachment to a part of a body;
a plurality of massage units, each massage unit being coupled to an associated one of said attachment members, each massage unit comprising
a substantially planar face,
a plurality of sockets coupled to and extending into said planar face,
a plurality of contact members, each contact member being positioned in and extending from an associated one of said sockets wherein an outer portion of each said contact member extends from said planar face, and
a plate, said plate abutting a base of each said socket, said plate being selectively vibrated wherein each said contact member vibrates; and
a plurality of control units, each control unit being coupled to an associated one of said attachment members, each massage unit being operationally coupled to an associated one of said control units.

2. The device of claim 1, further comprising said attachment members comprising a torso member, said torso member comprising a dorsal panel having an interior face and an exterior face, said torso member comprising a pair of shoulder straps, each of said shoulder straps having opposite ends coupled to said dorsal panel wherein said interior face of said dorsal panel is configured for abutting a back of a wearer when said shoulder straps are extended over shoulders of the wearer.

3. The device of claim 2, further comprising said massage units comprising a dorsal torso unit, said dorsal torso unit being coupled to said dorsal panel such that said contact members of said dorsal torso unit extend from said interior face of said dorsal panel.

4. The device of claim 2, further comprising said massage units comprising a pair of shoulder units, each shoulder unit being coupled to an associated one of said shoulder straps such that said contact members of each of said shoulder units extend from an inwardly facing surface of said associated shoulder strap.

5. The device of claim 2, further comprising a chest strap having first and second ends coupled to said dorsal panel, said chest strap having an adjustable length.

6. The device of claim 5, further comprising a chest buckle having selectively separable portions coupled to respective first and second sections of said chest strap.

7. The device of claim 1, further comprising:
said attachment members comprising a glove member, said glove member having a palm section; and
said massage units comprising a palm unit, said palm unit being coupled to said glove member such that said contact members of said palm unit extend inwardly into an interior space of said glove member, said contact members of said palm unit extending from said palm section of said glove member.

8. The device of claim 1, further comprising:
said attachment members comprising a sock member, said sock member having a base section; and
said massage units comprising a foot unit, said foot unit being coupled to said sock member such that said contact members of said foot unit extend inwardly into an interior space of said sock, said contact member of said foot unit extending from said base section of said sock member.

9. The device of claim 1, further comprising:
said massage units comprising a first extremity unit and a second extremity unit; and
said attachment members comprising an extremity member, said extremity member comprising connection strap coupled to and extending between said first extremity unit and said second extremity unit, said extremity member further comprising a fastening strap, said fastening strap having a free end removably coupled to said extremity member wherein said extremity member is configured for attachment around an extremity of the wearer such that said contact members of said first and said second extremity units face and contact the extremity of the wearer.

10. The device of claim 9, further comprising said connection strap being one of a plurality of said connection straps coupled to and extending between said first extremity unit and said second extremity unit.

11. The device of claim 9, further comprising said fastening strap being one of a plurality of said fastening straps coupled to said extremity member.

12. The device of claim 9, further comprising complimentary portions of hook and loop fastener being coupled to said extremity member and said fastening strap wherein said fastening strap is selectively removably coupled to said extremity member.

13. The device of claim 1, further comprising each said control unit having an activation switch operationally coupled to said plate of each said associated massage unit.

14. The device of claim 13, further comprising said activation switch having a plurality of settings and being operationally coupled to said plate of each said associated massage unit wherein said plate of each said associated massage unit vibrates at a selectable intensity.

15. The device of claim 1, further comprising a plurality of heating elements, each heating element being coupled to an associated one of said plates wherein each massage unit selectively provides heat transferred through said contact members of said associated massage unit.

16. The device of claim 15, further comprising each said control unit having a heat switch operationally coupled to said heating element of said associated massage unit.

17. A massage device comprising:
a plurality of attachment members, each attachment member being configured for attachment to a part of a body, said attachment members comprising
a torso member, said torso member comprising a dorsal panel having an interior face and an exterior face, said torso member including a pair of shoulder straps, each of said shoulder straps having opposite ends coupled to said dorsal panel wherein said interior face of said dorsal panel is configured for abutting a back of a wearer when said shoulder straps are extended over shoulders of the wearer,
a sock member, said sock member having a base section, and
a glove member, said glove member having a palm section;
a plurality of massage units, each massage unit being coupled to an associated one of said attachment members, each massage unit comprising
a substantially planar face,
a plurality of sockets coupled to and extending into said planar face,
a plurality of contact members, each contact member being positioned in and extending from an associated one of said sockets wherein an outer portion of each said contact member extends from said planar face, and
a plate, said plate abutting a base of each said socket, said plate being selectively vibrated wherein each said contact member vibrates;
said plurality of massage units comprising
a dorsal torso unit, said dorsal torso unit being coupled to said dorsal panel such that said contact members of said dorsal torso unit extend from said interior face of said dorsal panel,
a pair of shoulder units, each shoulder unit being coupled to an associated one of said shoulder straps such that said contact members of each of said shoulder units extend from an inwardly facing surface of said associated shoulder strap,
a foot unit, said foot unit being coupled to said sock member such that said contact members of said foot unit extend inwardly into an interior space of said sock, said contact member of said foot unit extending from said base section of said sock member,
a palm unit, said palm unit being coupled to said glove member such that said contact members of said palm unit extend inwardly into an interior space of said glove member, said contact members of said palm unit extending from said palm section of said glove member, and
a first extremity unit, and a second extremity unit;
said attachment members further comprising an extremity member, said extremity member comprising connection strap coupled to and extending between said first extremity unit and said second extremity unit, said extremity member further comprising a fastening strap, said fastening strap having a free end removably coupled to said extremity member wherein said extremity member is configured for attachment around an extremity of the wearer such that said contact members of said first and said second extremity units face and contact the extremity of the wearer, said connection strap being one of a plurality of said connection straps coupled to and extending between said first extremity unit and said second extremity unit, said fastening strap being one of a plurality of said fastening straps coupled to said extremity member, complimentary portions of hook and loop fastener being coupled to said extremity member and said fastening strap wherein said fastening strap is selectively removably coupled to said extremity members plurality of heating elements, each heating element being coupled to an associated one of said plates wherein each massage unit selectively provides heat transferred through said contact members of said associated massage unit;
a plurality of control units, each control unit being coupled to an associated one of said attachment members, each massage unit being operationally coupled to an associated one of said control units, each said control unit having an activation switch operationally coupled to said plate of each said associated massage unit, said activation switch having a plurality of settings and being operationally coupled to said plate of each said associated massage unit wherein said plate of each said associated massage unit vibrates at a selectable intensity, each said control unit having a heat switch operationally coupled to said heating element of said associated massage unit;
a chest strap having first and second ends coupled to said dorsal panel, said chest strap having an adjustable length; and
a chest buckle having selectively separable portions coupled to respective first and second sections of said chest strap.
